(19) United States
(12) Patent Application Publication
(10) Pub. No.: US 2025/0247806 A1
(43) Pub. Date: Jul. 31, 2025

(54) UPLINK TRANSMISSION TIMER EXTENSION

(71) Applicant: QUALCOMM Incorporated, San Diego, CA (US)

(72) Inventors: Bharat SHRESTHA, San Diego, CA (US); Alberto RICO ALVARINO, San Diego, CA (US); Umesh PHUYAL, San Diego, CA (US)

(21) Appl. No.: 18/428,430

(22) Filed: Jan. 31, 2024

(51) Int. Cl. H04W 56/00; H04W 8/22; H04W 80/02

(52) U.S. Cl. CPC H04W 56/009; H04W 8/22; H04W 56/0045; H04W 80/02

(57) ABSTRACT

Various aspects of the present disclosure generally relate to wireless communication. In some aspects, a UE may receive a closed loop timing advance command message including an indicator associated with the closed loop timing advance command message, the indicator including at least one of a timing advance value or an uplink transmission extension indication. The UE may transmit one or more communications on an uplink in accordance with an interpretation of the closed loop timing advance command message, the interpretation of the closed loop timing advance command message being based on the indicator. Numerous other aspects are described.

### INTRODUCTION

Aspects of the present disclosure generally relate to wireless communication and specifically relate to techniques, apparatuses, and methods for uplink transmission.

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed at a user equipment (UE). The method may include receiving a closed loop timing advance command message including an indicator associated with the closed loop timing advance command message, the indicator including at least one of a timing advance value or an uplink transmission extension indication. The method may include transmitting one or more communications on an uplink in accordance with an interpretation of the closed loop timing advance command message, the interpretation of the closed loop timing advance command message being based on the indicator.

Some aspects described herein relate to a method of wireless communication performed by a network node. The method may include transmitting a closed loop timing advance command message including an indicator associated with the closed loop timing advance command message, the indicator including at least one of a timing advance value or an uplink transmission extension indication. The method may include receiving one or more communications on an uplink in accordance with an interpretation of the closed loop timing advance command message, the interpretation of the closed loop timing advance command message being based on the indicator.

Some aspects described herein relate to a UE for wireless communication. The UE may include one or more memories and one or more processors coupled to the one or more memories. The one or more processors may be configured to receive a closed loop timing advance command message including an indicator associated with the closed loop timing advance command message, the indicator including at least one of a timing advance value or an uplink transmission extension indication. The one or more processors may be configured to transmit one or more communications on an uplink in accordance with an interpretation of the closed loop timing advance command message, the interpretation of the closed loop timing advance command message being based on the indicator.

Some aspects described herein relate to a network node for wireless communication. The network node may include one or more memories and one or more processors coupled to the one or more memories. The one or more processors may be configured to transmit a closed loop timing advance command message including an indicator associated with the closed loop timing advance command message, the indicator including at least one of a timing advance value or an uplink transmission extension indication. The one or more processors may be configured to receive one or more communications on an uplink in accordance with an interpretation of the closed loop timing advance command message, the interpretation of the closed loop timing advance command message being based on the indicator.

Some aspects described herein relate to a non-transitory computer-readable medium that stores a set of instructions for wireless communication by a UE. The set of instructions, when executed by one or more processors of the UE, may cause the UE to receive a closed loop timing advance command message including an indicator associated with the closed loop timing advance command message, the indicator including at least one of a timing advance value or an uplink transmission extension indication. The set of instructions, when executed by one or more processors of the UE, may cause the UE to transmit one or more communications on an uplink in accordance with an interpretation of the closed loop timing advance command message, the interpretation of the closed loop timing advance command message being based on the indicator.

Some aspects described herein relate to a non-transitory computer-readable medium that stores a set of instructions for wireless communication by a network node. The set of instructions, when executed by one or more processors of the network node, may cause the network node to transmit a closed loop timing advance command message including an indicator associated with the closed loop timing advance command message, the indicator including at least one of a timing advance value or an uplink transmission extension indication. The set of instructions, when executed by one or more processors of the network node, may cause the network node to receive one or more communications on an uplink in accordance with an interpretation of the closed loop timing advance command message, the interpretation of the closed loop timing advance command message being based on the indicator.

Some aspects described herein relate to an apparatus for wireless communication. The apparatus may include means for receiving a closed loop timing advance command message including an indicator associated with the closed loop timing advance command message, the indicator including at least one of a timing advance value or an uplink transmission extension indication. The apparatus may include means for transmitting one or more communications on an uplink in accordance with an interpretation of the closed loop timing advance command message, the interpretation of the closed loop timing advance command message being based on the indicator.

Some aspects described herein relate to an apparatus for wireless communication. The apparatus may include means for transmitting a closed loop timing advance command message including an indicator associated with the closed loop timing advance command message, the indicator including at least one of a timing advance value or an uplink transmission extension indication. The apparatus may include means for receiving one or more communications on an uplink in accordance with an interpretation of the closed loop timing advance command message, the interpretation of the closed loop timing advance command message being based on the indicator.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated improvements will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated improvements, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless network in accordance with the present disclosure.

FIG. 3 is a diagram illustrating an example disaggregated base station architecture in accordance with the present disclosure.

FIG. 4 is a diagram illustrating an example of downlink and uplink transmissions between a network node and a UE in a wireless network, in accordance with the present disclosure.

FIG. 5 is a diagram illustrating an example of uplink transmission timer extension, in accordance with the present disclosure.

FIG. 6 is a diagram illustrating an example associated with uplink transmission timer extension, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram illustrating an example of a hardware implementation for an apparatus employing a processing system, in accordance with the present disclosure.

FIG. 11 is a diagram illustrating an example of an implementation of code and circuitry for an apparatus, in accordance with the present disclosure.

FIG. 12 is a diagram of an example apparatus for wireless communication, in accordance with the present disclosure.

FIG. 13 is a diagram illustrating an example of a hardware implementation for an apparatus employing a processing system, in accordance with the present disclosure.

FIG. 14 is a diagram illustrating an example of an implementation of code and circuitry for an apparatus, in accordance with the present disclosure.

### DETAILED DESCRIPTION

A user equipment (UE) may use positioning information, such as information that identifies a location of the UE, a speed and direction that the UE is traveling, or another characteristic of the UE, for one or more purposes when operating in a network. For example, the UE may use information identifying a location of the UE to determine which cells or radio access technologies (RATs) are available at the location of the UE. In this example, the UE may connect to a cell or RAT that is available at the location of the UE. In another example, the UE may use information identifying a speed and direction of travel of the UE to determine that the UE is moving from a first coverage area of a first cell to a second coverage area of a second cell. In this example, the UE may proactively perform a mobility operation to transfer from receiving network service via the first cell to receiving network service via the second cell. In yet another example, the UE may use positioning information to determine timing information.

The UE may determine a propagation delay associated with communications between a first location of the UE and a second location of a network node. The propagation delay may include a period of time, which may be on an order of several milliseconds (ms), during which a transmission propagates from the first location of the UE to the second location of the network node. In some examples, the propagation delay may include a period of time associated with transmitting the transmission (e.g., a period of time between generating the waveform and the waveform being transmitted by an antenna at the UE) or a period of time associated with receiving the transmission (e.g., a period of time between receiving a waveform at an antenna of the network node and processing the transmission to derive information being conveyed by the waveform).

The UE may, based on the propagation delay, adjust a monitoring period or a transmission period to ensure synchronization between a first timing at the UE and a second timing at the network node. The monitoring period may include a period of time during which the UE monitors for transmissions (e.g., from a network node or from another UE). Similarly, the transmission period may include a period of time during which the UE transmits a communication (e.g., to a network node or another UE). For example, the UE may shift the monitoring period, based on the propagation delay, such that the UE is monitoring for communications at a period of time when the communications will arrive (when accounting for the propagation delay) rather than a period of time when the communications were transmitted. Similarly, the UE may shift a transmission period, based on the propagation delay, such that, when a communication arrives at a target (e.g., a network node or another UE), the target is monitoring for the communication.

Different technologies are available for the UE to determine positioning information. For example, some UEs may determine speed and direction information using one or more accelerometers of the UE. In this example, by measuring an amount of acceleration in one or more directions, the UE can estimate a speed and/or direction of travel. Some UEs may use triangulation or trilateration techniques to determine positioning information. For example, a UE may measure a set of signals from a set of sources (e.g., a set of base stations) and triangulate a location of the UE, relative to the set of sources, based on characteristics of the set of signals (e.g., signal strengths, signal delays, or Doppler shift). Some UEs may use non-terrestrial navigation sources for determining positioning information. For example, a UE may receive a set of signals from a global navigation satellite system (GNSS) provider and use the signals to perform, for example, a triangulation or trilateration determination. Examples of GNSS providers that provide positioning, navigation, and timing (PNT) services include the Global Positioning System (GPS), the BeiDou Navigation Satellite System (BDS), and the Galileo Navigation System, among other examples. Different GNSS providers may be available at different locations, to different UEs, and/or at different granularity levels.

When a UE uses inaccurate positioning information the UE may determine an inaccurate propagation delay. This may result in the UE transmitting communications that arrive at a target when the target is not monitoring for the communications. Similarly, this may result in the UE monitoring for communications at a time when the communications are not arriving at the UE. Accordingly, using inaccurate positioning information can result in dropped communications, retransmissions, missed bits (e.g., which are then recovered using processor-intensive error recovery schemes), or other issues. Accordingly, a UE may update positioning information periodically to avoid excess utilization of processing resources or power resources.

To update positioning information, a UE may trigger a GNSS measurement.

A GNSS measurement may include a determination of a transmission time of a set of GNSS signals, an angle of reception of the set of GNSS signals, a carrier phase measurement of the set of GNSS signals, or another type of measurement. In some scenarios, the UE may be unable to trigger a GNSS measurement during a period of time, which may be referred to as a “GNSS validity period.” The GNSS validity period may include a period of time during which a GNSS measurement is treated as valid. In other words, the GNSS validity period is a period of time when the UE is able to use a GNSS measurement without errors in positioning information. Accordingly, GNSS invalidity is a UE state in which a most recent GNSS measurement has not occurred within a configured amount of time.

One example in which the UE may not be able to trigger a GNSS measurement during the GNSS validity period is when the UE is transmitting high priority communications on an uplink. In this example, the UE may not be able to interrupt the high priority communications on an uplink to perform a GNSS measurement on a downlink. In Internet of Things (IoT) non-terrestrial network (NTN) deployments, GNSS validity expires when a validity timer associated with updating the positioning information expires without a UE having performed a GNSS measurement and reset the validity timer. When a UE's GNSS validity expires, the UE's position is considered outdated and a timing that is based on the UE's position is considered not valid. When the timing is considered not valid, the UE may lack uplink synchronization with a network node (e.g., an NTN network node) that is providing network services to the UE. When the UE lacks uplink synchronization, the UE may transition from a radio resource control (RRC) connected mode to an RRC idle mode. In the RRC idle mode, the UE can update positioning information to return the positioning information and GNSS validity to a valid state.

However, in some scenarios, it is desirable for the UE to continue transmitting on an uplink even when GNSS validity has expired. For example, in an emergency communication scenario, a trade-off between some dropped communications resulting from a lack of uplink synchronization and a complete communication interruption associated with entering RRC idle mode and updating the GNSS validity may be balanced toward some dropped communications occurring. In such scenarios, the UE may have a UE capability of remaining in an RRC connected mode after GNSS validity expires.

When GNSS validity becomes outdated, and the UE is configured to remain in RRC connected mode, the UE may start a timer, T3xx, for continuing uplink transmission. The UE starts the timer T3xx when a GNSS validity timer expires (and GNSS validity becomes outdated), and uses the timer T3xx to track a period of time in which the UE continues to be able to transmit on an uplink (and forgoes a transition to an RRC idle mode), despite the GNSS invalidity. In other words, as long as the timer, T3xx, remains running, the UE maintains an uplink synchronization state and can perform uplink transmission, despite the GNSS validity expiring. After the timer, T3xx, expires, the UE may transition to the RRC idle mode to recover GNSS validity. A network node may transmit, via RRC signaling, a medium access control (MAC) control element (CE) message to request that the UE reset the timer, T3xx. For example, before the timer, T3xx, expires and when the UE has a configured amount of data for uplink transmission or a configured priority of data for uplink transmission, the network node may request that the UE reset the timer, T3xx. Additional details regarding the timer, T3xx, and extension thereof are described with regard to 3GPP Technical Specification (TS) 36.331, Release 18, Version 18.0.0. By resetting the timer, T3xx, the UE can extend the period in which the UE continues uplink transmission despite a lack of GNSS validity. Different formats of MAC CE messages are specified for a UE to receive commands relating to timing. The UE may lack information associated with distinguishing between the different formats, and associated different purposes, of the different MAC CEs. When the UE cannot distinguish between the different formats and associated different purposes, the UE may not interpret a received MAC CE correctly and receive a command that the network node is attempting to transmit to the UE. By not receiving the command, the UE may not be able to extend the timer T3xx and continue transmitting.

Various aspects relate generally to uplink transmission timer extension. Some aspects more relate to a single MAC CE format that can be used for conveying an uplink transmission extension command, for resetting the timer, T3xx, and for conveying a timing advance (TA) command, such as a closed loop TA command. A closed loop TA command may refer to a TA value that is signaled by the network node to the UE. In contrast, an open loop TA command is a TA value determined by the UE, autonomously, without receiving explicit signaling from the network node identifying a TA value. In some aspects, a network node may configure a reserved bit indicator in a MAC CE to indicate whether the MAC CE is signaling a TA command, such as a closed loop TA command used for closed loop timing control, or an uplink transmission extension command. For example, the network node may set a language code identifier (LCID) codepoint to indicate that the MAC CE conveys a TA command, an uplink transmission extension, or a TA command with an uplink transmission extension. Additionally, or alternatively, the network node may set a timing advance group (TAG) identity in a TA command to indicate whether a MAC CE conveys a TA command, an uplink transmission extension, or a TA command with an uplink transmission extension.

When the UE receives the MAC CE, the UE may use an indicator in the MAC CE to determine how to interpret one or more fields of or a purpose of the MAC CE. For example, the UE may interpret an indicator in the MAC CE as indicating that the MAC CE is associated with conveying an uplink transmission extension, a TA command, or both an uplink transmission extension and a TA command. In this example, the UE may interpret, as the indicator, an LCID codepoint or another reserved bit indicator. Accordingly, the UE may interpret a TA command or TAG ID of the MAC CE based on a value in the LCID codepoint or the other reserved bit indicator. For example, the UE may interpret the TA command as conveying a TA value.

Particular aspects of the subject matter described in this disclosure can be implemented to realize one or more of the following potential improvements. In some examples, by including an indicator in a MAC CE to indicate a MAC CE purpose, the described techniques can be used to provide a TA command, an uplink transmission extension, or a TA command with an uplink transmission extension within the same format of MAC CE. The uplink transmission extension may be an indication to reset the T3xx timer, thereby causing the UE to be able to continue transmitting on an uplink during a GNSS invalidity period. The TA command may be associated with configuring a timing for UE transmissions during the extension of uplink transmission. By providing a plurality of possible messages using the same format of MAC CE, the described techniques improve signaling flexibility without additional signaling overhead. By providing an uplink transmission extension within a TA command MAC CE, the described techniques improve network flexibility with respect to extending uplink transmission by a UE after an expiration of GNSS validity.

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

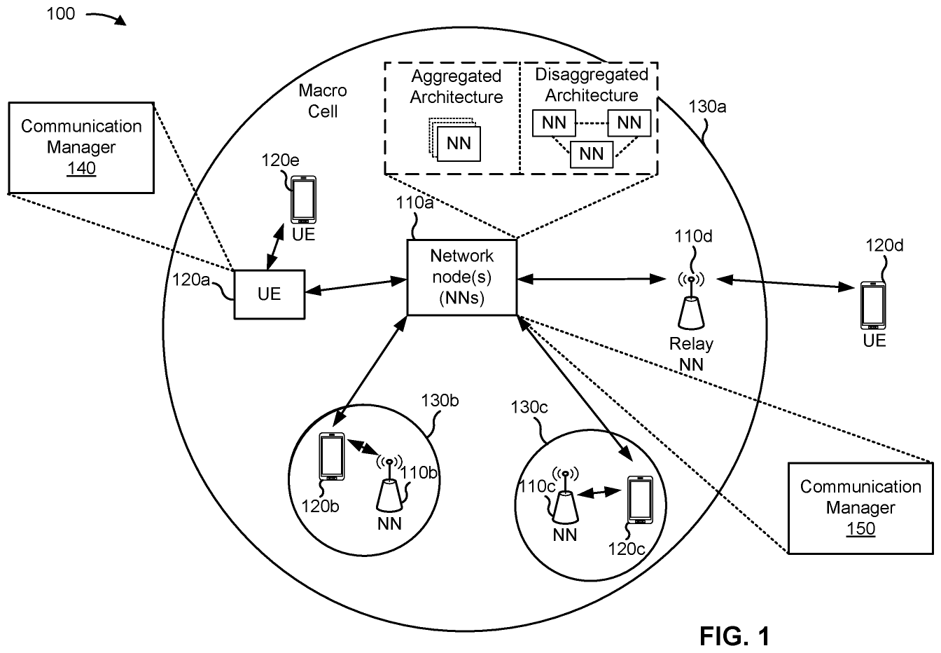

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In one or more examples, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). A processor also may be implemented as a combination of computing devices, for example, a combination of a DSP and a microprocessor, a plurality of microprocessors, one or more microprocessors in conjunction with a DSP core, or any other such configuration. One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 includes means for receiving a closed loop timing advance command message including an indicator associated with the closed loop timing advance command message, the indicator including at least one of a timing advance value or an uplink transmission extension indication; and/or means for transmitting one or more communications on an uplink in accordance with an interpretation of the closed loop timing advance command message, the interpretation of the closed loop timing advance command message being based on the indicator. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a closed loop timing advance command message including an indicator associated with the closed loop timing advance command message, the indicator including at least one of a timing advance value or an uplink transmission extension indication; and/or means for receiving one or more communications on an uplink in accordance with an interpretation of the closed loop timing advance command message, the interpretation of the closed loop timing advance command message being based on the indicator. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 1 is provided as an example. Other examples may differ from what is described with regard to FIG. 1.

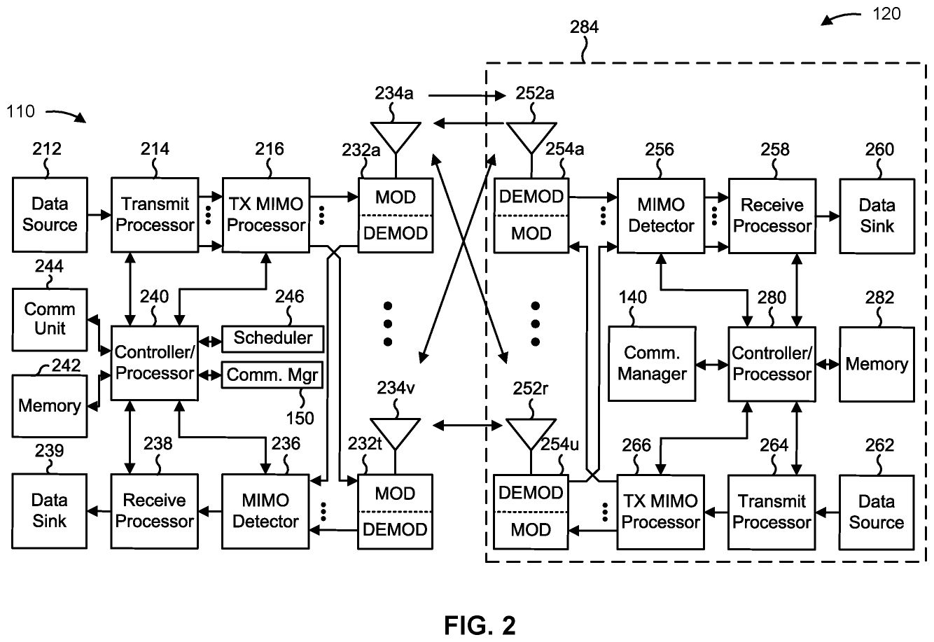

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

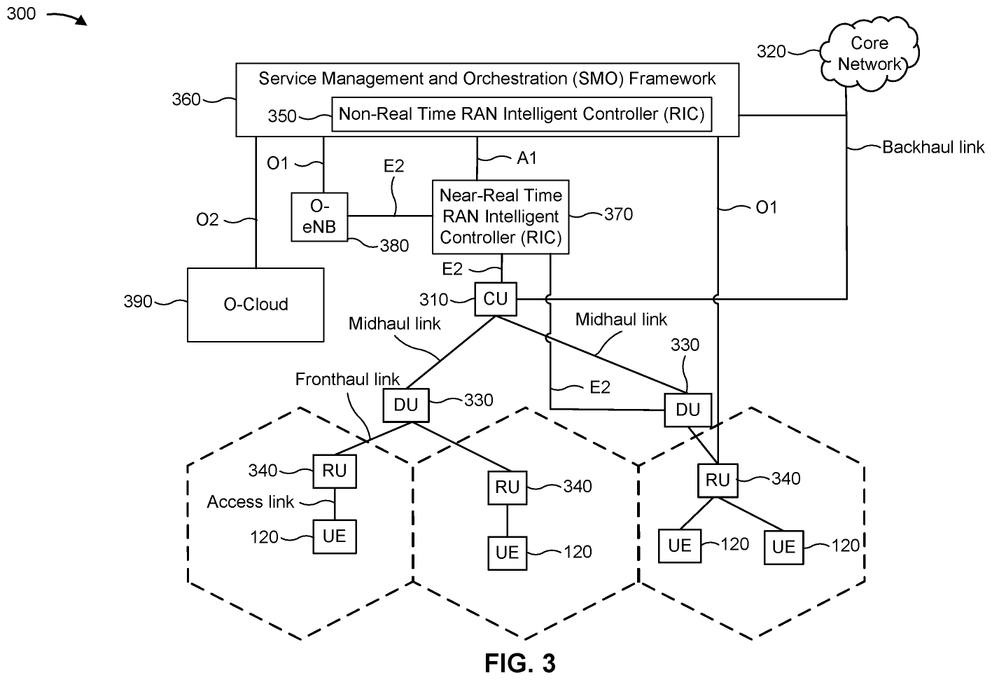

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

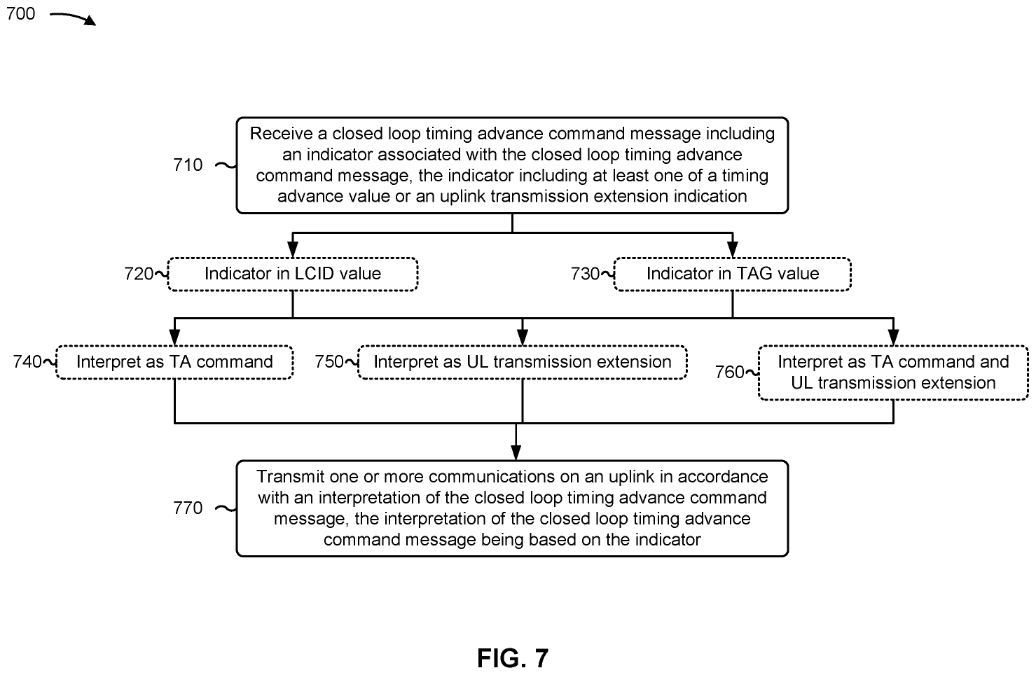

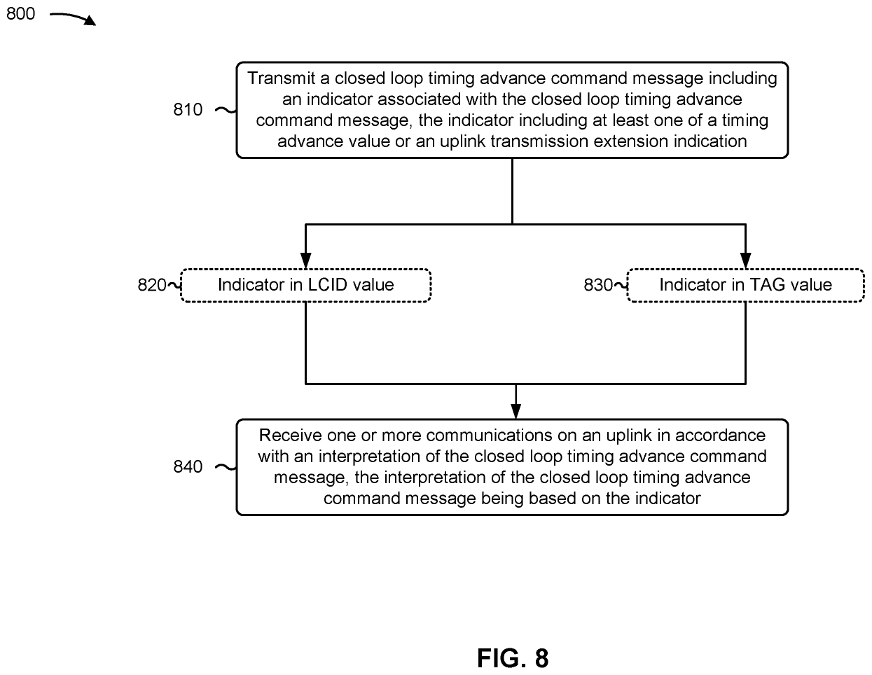

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with uplink transmission timer extension, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

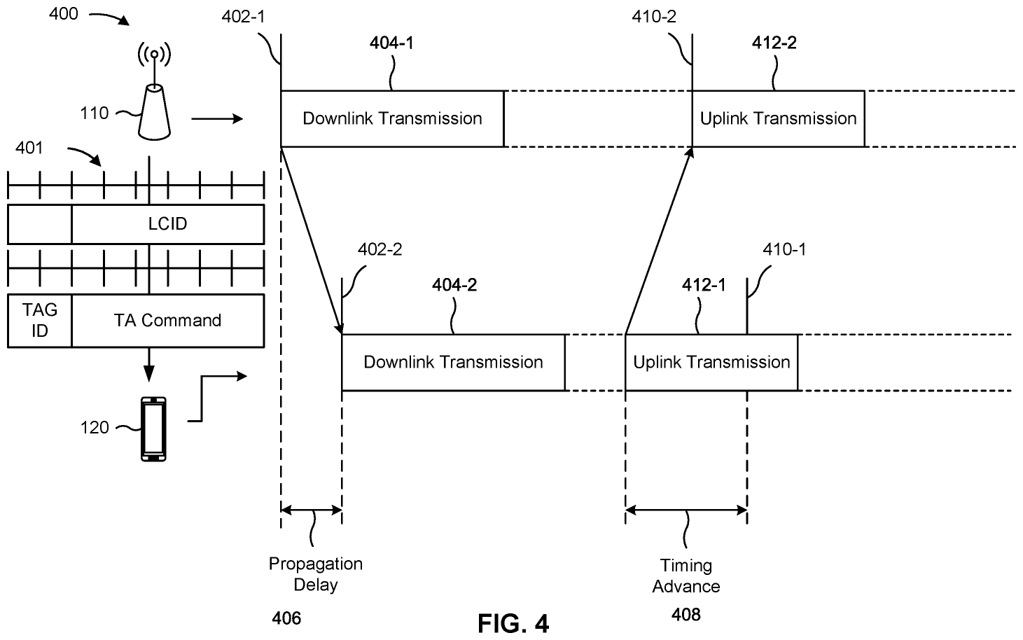

FIG. 4 is a diagram illustrating an example 400 of downlink and uplink transmissions between a network node 110 and a UE 120 in a wireless network 100, in accordance with the present disclosure. In some examples, the downlink and/or uplink transmissions are based at least in part on a timing advance and/or a guard period between communications. As one example, a network node 110 may configure a downlink transmission to end before the start of a guard period. As another example, the UE 120 may advance a start time for an uplink transmission based at least in part on a timing advance.

As shown by reference number 402-1, a network node 110 may begin a downlink transmission 404-1 to a UE 120 at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (msec)). Each radio frame may be further partitioned into a set of Z (Z≥1) subframes, where each subframe may have a predetermined duration (e.g., 1 msec). Each subframe may be further partitioned into a set of slots and/or each slot may include a set of L symbol periods (e.g., fourteen symbol periods, seven symbol periods, or another number of symbol periods). Thus, the first point in time as shown by the reference number 402-1 may be based at least in part on a time partition as defined by a telecommunication system (e.g., a frame, a subframe, a slot, a mini-slot, and/or a symbol).

In some examples, the network node 110 and the UE 120 may wirelessly communicate with one another (e.g., directly or via one or more network nodes) based at least in part on the defined time partitions. However, each device may have different timing references for the time partitions. To illustrate, and as shown by the reference number 402-1, the network node 110 may begin the downlink transmission 404-1 at a particular point in time that may be associated with a defined time partition based at least in part on a time perspective of the network node 110. For example, the network node 110 may associate the particular point in time with a defined time partition, such as a beginning of a symbol, a beginning of a slot, a beginning of a subframe, and/or a beginning of a frame.

However, the downlink transmission may incur a propagation delay 406 in time, such as a time delay based at least in part on the downlink transmission traveling between a network node 110 (e.g., an RU) and the UE 120. As shown by reference number 402-2, the UE 120 may receive downlink transmission 404-2 (corresponding to downlink transmission 404-1 transmitted by the network node 110) at a second point in time that is later in time relative to the first point in time. From a time perspective of the UE 120, however, the UE 120 may associate the second point in physical time shown by the reference number 402-2 with the same particular point in time of the defined time partition as the network node 110 (e.g., a beginning of the same symbol, a beginning of the same mini-slot, a beginning of the same slot, a beginning of the same subframe, and/or a beginning of the same frame). Thus, as shown by the example 400, the time perspective of the UE 120 may be delayed in time from the time perspective of the network node 110.

In wireless communication technologies like 4G/LTE and 5G/NR, a timing advance (TA) value is used to control a timing of uplink transmissions by a UE (e.g., UE 120 and/or the like) such that the uplink transmissions are received by a network node 110 (e.g., an RU) at a time that aligns with an internal timing of the network node 110. A network node 110 may determine the TA value to a UE (e.g., directly or via one or more network nodes) by measuring a time difference between reception of uplink transmissions from the UE and a subframe timing used by the network node 110 (e.g., by determining a difference between when the uplink transmissions were supposed to have been received by the network node 110, according to the subframe timing, and when the uplink transmissions were actually received). The network node 110 may transmit a TA command (TAC) to instruct the UE to transmit future uplink communications earlier or later to reduce or eliminate the time difference and align timing between the UE and network node 110. For example, as shown by reference number 401, the network node 110 may transmit a MAC CE that includes a timing advance command as at least one octet of the MAC CE. The MAC CE includes a timing advance group (TAG) identifier and the TA command. The TAG identifier indicates to which TAG the TA command is applicable. In some examples, the MAC CE may include a language code identifier (LCID) codepoint, as described in more detail herein. The TA command is used to offset timing differences between the UE and the network node 110 due to different propagation delays that occur when the UE is different distances from the network node 110. If TA commands were not used, then uplink transmissions from different UEs (e.g., located at different distances from the network node 110) may collide due to mistiming even if the uplink transmissions are scheduled for different subframes.

To illustrate, without adjusting a start time of an uplink transmission, the UE 120 may be configured to begin an uplink transmission at a scheduled point in time based at least in part on the defined time partitions as described elsewhere herein. As shown by reference number 410-1, a start of the scheduled point in time may occur at a third physical point in time based at least in part on the timing perspective of the UE 120. However, and as shown by reference number 410-2, the scheduled point in time with reference to the timing perspective of the network node 110 (e.g., an RU) may occur at a fourth point in physical time that occurs before the third point in physical time as shown by the reference number 410-1. Accordingly, the network node 110 may instruct the UE 120 (e.g., directly or via one or more network nodes) to apply a timing advance 408 to an uplink transmission to better align reception of the uplink transmission with the timing perspective of the network node 110. However, in some examples, the fourth point in time shown by the reference number 410-2 may occur at or near a same physical point in time as the third point in time shown by the reference number 410-1 such that uplink transmissions from the UE 120 to the network node 110 incur the propagation delay 406. In such a scenario, the network node 110 may instruct the UE 120 to apply a timing advance with a time duration corresponding to the propagation delay 406. The network node 110 may transmit a medium access control (MAC) control element (CE) with a configured format to convey a timing advance command or timing advance value associated with identifying the timing advance.

As shown by the example 400, the UE 120 may adjust a start time of an uplink transmission 412-1 based at least in part on the timing advance 408 and the start of the scheduled point in time (e.g., at the third physical point in time shown by the reference number 410-1). Based at least in part on propagation delay, the network node 110 may receive an uplink transmission 412-2 (corresponding to the uplink transmission 412-1 transmitted by the UE 120) at the fourth point in physical time shown by the reference number 410-2.

In some examples, a timing advance value may be based at least in part on twice an estimated propagation delay (e.g., the propagation delay 406) and/or may be based at least in part on a round trip time (RTT). Some network deployments, such as non-terrestrial network (NTN) deployments or network deployments with repeaters, may have relatively large RTT values, which may make the use of a timing advance beneficial to avoid resource conflicts and/or dropped communications. A network node 110 (e.g., a DU or a CU) may estimate the propagation delay and/or select a timing advance value based at least in part on communications with the UE 120. As one example, the network node 110 may estimate the propagation delay based at least in part on a network access request message from the UE 120. Additionally, or alternatively, the network node 110 may estimate and/or select the timing advance value from a set of fixed timing advance values.

As indicated above, FIG. 4 is provided as an example. Other examples may differ from what is described with regard to FIG. 4.

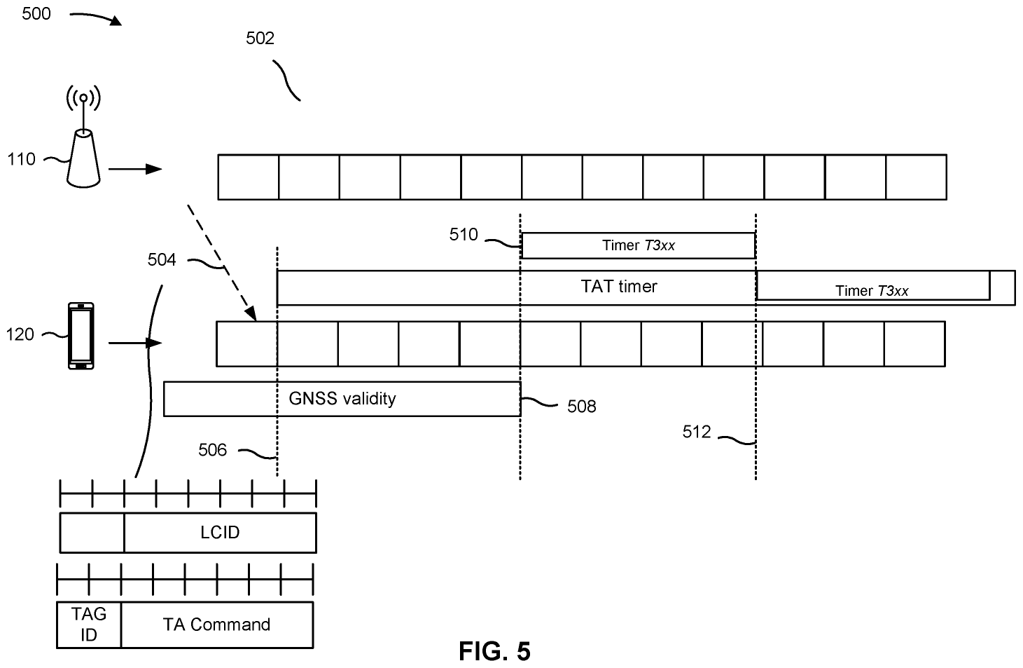

FIG. 5 is a diagram illustrating an example 500 of uplink transmission timer extension, in accordance with the present disclosure. As shown in FIG. 5, example 500 includes communication between a network node 110 and a UE 120.

As shown in FIG. 5, and by reference number 502, the UE 120 and the network node 110 may communicate in a set of resources, such as a set of resource blocks (RBs), a set of symbols, a set of slots, or a set of frames, among other examples. For example, the UE 120 may transmit on an uplink to the network node 110. As shown by reference number 504, the UE 120 may receive a TA command from the network node 110. For example, the UE 120 may receive a MAC CE associated with conveying a TA command to maintain timing synchronization between the UE 120 and the network node 110. As shown, the MAC CE may include a TAG ID and a TA command. Further, the MAC CE may include a MAC subheader with a language code identifier (LCID) codepoint. The LCID codepoint may be a configurable value that can be assigned for one or more indications, such as an indication of a recommended bit rate, an indication of a TA command, a set of padding bits, or may be reserved for another purpose, as described herein. As shown by reference number 506, at a first time, based on receiving the TA command from the network node 110, the UE 120 may start a timing alignment timer (TAT timer). For example, the UE 120 may start the TAT timer to track a period of time during which the UE 120 maintains timing synchronization with the network node 110 based on having received the TA command.

As further shown in FIG. 5, and by reference number 508, at a second time, a global navigation satellite system (GNSS) validity expires for the UE 120. GNSS validity is a period of time, after performing a GNSS measurement, during which positioning information of the UE 120 is considered valid. In other words, the UE 120 performs a measurement of a GNSS signal and can determine positioning information (e.g., a location, a speed, a direction) based on the measurement of the GNSS signal (e.g., using triangulation or trilateration). After performing the measurement of the GNSS signal, the UE 120 starts a GNSS validity timer. Each time the UE 120 performs another GNSS measurement, the UE 120 resets the GNSS validity timer. However, when the GNSS validity timer expires without the UE 120 having performed a GNSS measurement, the UE 120 may consider the positioning information to be outdated and uplink synchronization with the network node 110 (e.g., which is calculated by based on a first position of the UE 120 and a second position of the network node 110, in an NTN deployment) to be not valid. When the GNSS validity expires, the UE 120 may transition to a radio resource control (RRC) idle mode (e.g., from an RRC connected mode) to recover GNSS validity.

However, when the UE 120 has received a TA command to synchronize timing with the network node 110, the UE 120 may extend uplink transmission for a period of time. For example, as shown by reference number 510, the UE 120 may start an uplink transmission extension timer T3xx. During an uplink transmission extension period associated with the timer T3xx, the UE 120 can continue to transmit on an uplink using timing synchronization derived from the timing advance command. As shown by reference number 512, at an expiration of the uplink transmission extension timer T3xx, the TAT timer may not have expired. In other words, the uplink transmission extension period associated with the timer T3xx has expired, but the timing advance command that synchronizes the UE 120 with the network node 110 is still valid. Accordingly, the UE 120 may be able to start a new uplink transmission extension period associated with a reset timer T3xx. However, without established signaling from the network node 110 to instruct the reset of the timer T3xx, there may be ambiguity between the network node 110 and the UE 120 as to whether the UE 120 has reset the timer T3xx or transitioned to an RRC idle state to recover GNSS validity. In such a scenario, the network node 110 may lose synchronization with the UE 120 and may experience a communication interruption.

As indicated above, FIG. 5 is provided as an example. Other examples may differ from what is described with respect to FIG. 5.

Various aspects relate generally to uplink transmission timer extension. Some aspects more specifically relate to a single MAC CE format that can be used for conveying an uplink transmission extension command, for resetting the timer, T3xx, and for conveying a TA command. In some aspects, a network node may configure a reserved bit indicator in a MAC CE to indicate whether the MAC CE is signaling a TA command or an uplink transmission extension command. For example, the network node may set a language code identifier (LCID) codepoint to indicate that the MAC CE conveys a TA command, an uplink transmission extension, or a TA command with an uplink transmission extension. The LCID codepoint may be conveyed in an LCID field of a MAC CE subheader. Additionally, or alternatively, the network node may set a timing advance group (TAG) identity in a TA command to indicate whether a MAC CE conveys a TA command, an uplink transmission extension, or a TA command with an uplink transmission extension.

Particular aspects of the subject matter described in this disclosure can be implemented to realize one or more of the following potential improvements. In some examples, by including an indicator in a MAC CE to indicate a MAC CE purpose, the described techniques can be used to provide a TA command, an uplink transmission extension, or a TA command with an uplink transmission extension within the same format of MAC CE. By providing a plurality of possible messages using the same format of MAC CE, the described techniques improve signaling flexibility without additional signaling overhead. By providing an uplink transmission extension within a TA command MAC CE, the described techniques improve network flexibility with respect to extending uplink transmission by a UE after an expiration of GNSS validity.

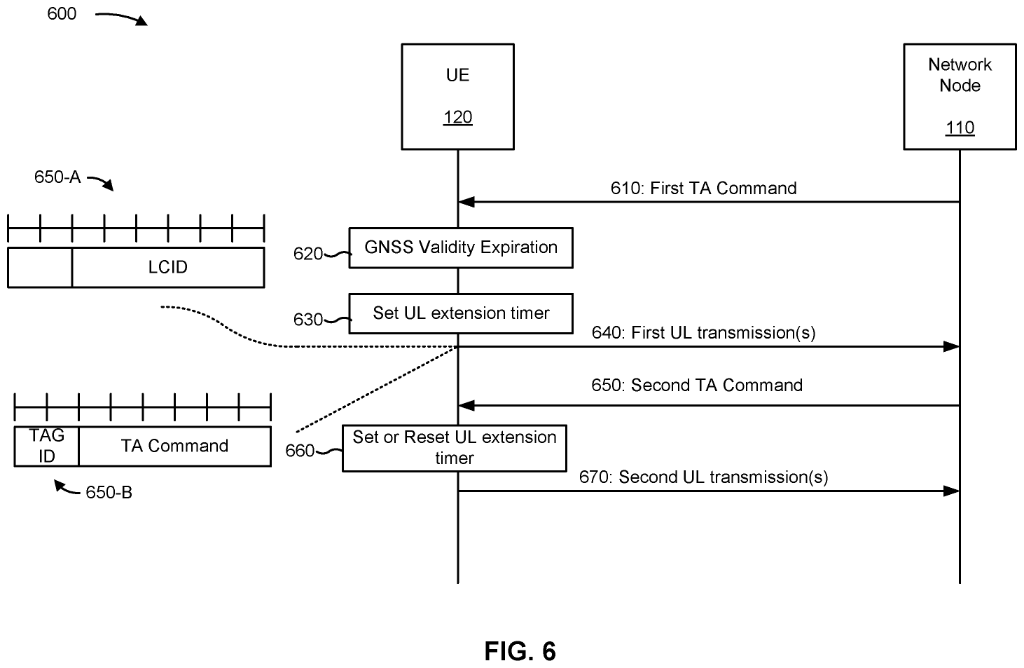

FIG. 6 is a diagram illustrating an example 600 associated with uplink transmission timer extension, in accordance with the present disclosure. As shown in FIG. 6, example 600 includes communication between a network node 110 and a UE 120.

As further shown in FIG. 6, and by reference number 610, the UE 120 may receive a TA command. For example, the UE 120 may receive a MAC CE with a configured format for conveying a TA command. In some aspects, the TA command may include a TA value that the UE 120 may use to synchronize communications with the network node 110. For example, the UE 120 may apply the TA value and may start a TAT timer associated with tracking a period of time during which the TA command remains valid.

As further shown in FIG. 6, and by reference number 620, the UE 120 may determine an expiration of GNSS validity. For example, the UE 120 may determine that a positioning timer associated with a GNSS measurement has expired. In this example, the UE 120 may determine that a new GNSS measurement has not been performed for at least a configured period of time and may determine that a previous GNSS measurement is not valid. As described above, in some scenarios, the UE 120 can enter an RRC idle mode to recover GNSS validity. However, as described herein, when the UE 120 is configured to extend uplink transmission using an uplink transmission extension timer T3xx, the UE 120 may avoid transferring to the RRC idle mode (e.g., from an RRC active mode) and may continue transmitting on an uplink. For example, as shown by reference number 630, the UE 120 may set the uplink transmission extension timer T3xx. Based on setting the uplink transmission extension timer T3xx, the UE 120 may transmit one or more first uplink transmissions, as shown by reference number 640.

As further shown in FIG. 6, and by reference number 650, the UE 120 may receive a TA command. For example, the UE 120 may receive a MAC CE in a configured format associated with conveying a TA command. In some aspects, the UE 120 may receive a second TA command after receiving a first TA command. For example, the UE 120 may receive a first TA command, which triggers the UE 120 to set a first uplink transmission extension timer, and may receive a second TA command that triggers the UE 120 to reset the first uplink transmission extension timer or set a second uplink transmission extension timer.

In some aspects, the network node 110 may configure a bit indicator in the MAC CE to indicate a purpose of or interpretation of the MAC CE. The MAC CE may include a timing advance command with an uplink transmission extension MAC CE, which is identified by a MAC protocol data unit (PDU) subheader with a configured indicator. For example, as shown by reference number 650-A, the network node 110 may configure a reserved LCID codepoint for downlink scheduling (DL-SCH) with a configured value. In this example, options for a value of the LCID codepoint may include a first value that indicates that the MAC CE is associated with a first behavior, such as applying a provided timing advance value. Additionally, or alternatively, the options for the value of the LCID codepoint may include a second value that indicates that the MAC CE is associated with a second behavior, such as extending uplink transmission after expiration of a current GNSS validity or restarting an uplink transmission extension timer T3xx. Additionally, or alternatively, the LCID codepoint may have a value, in a closed loop timing advance command message, that indicates that the closed loop timing advance command message conveys both a timing advance value and an uplink transmission extension. For example, the value of “01110”, as shown, may indicate that the MAC CE is associated with conveying both a TA command and an uplink transmission extension indication. In these examples, when the UE 120 receives the MAC CE and a MAC entity of the UE 120 reads the MAC CE command and LCID, the UE 120 may apply the MAC CE command to an uplink transmission extension timer T3xx.

In some aspects, the network node 110 may configure a TAG identity value in a TA command MAC CE. For example, as shown by reference number 650-B, the network node 110 may transmit a MAC CE that includes a repurposed the TAG identity value such that, when the network node 110 includes a configured value (e.g., 0, 1, or 2, among other examples) in a TAG identity value field, the UE 120 can interpret the TA command MAC CE with a configured behavior. In this example, the MAC CE may include 2 bits for conveying the TAG ID and 6 bits for conveying the TA command. In one or more examples, when the TAG identity value is 0, 1, or 2, the UE 120 may interpret the TA command MAC CE as providing both a TA command value and an uplink transmission extension indication. Alternatively, in the one or more examples, when the TAG identity value is 3, the UE 120 may interpret that TA command MAC CE as not providing an uplink transmission extension indication (despite uplink transmission extension being enabled for the UE 120). In other words, when the TA command MAC CE is configured with uplink transmission extension, a configured TAG identity value (e.g., “3” or a bit value of “11”) indicates that, for example, a special cell (SpCell) has a TAG identity of “0” and uplink transmission extension does not apply (to the particular TA command MAC CE).

In some aspects, the UE 120 may interpret the TAG identity value as indicating whether the TA command MAC CE provides an uplink transmission extension indication based on a network node 110 configuration. For example, the network node 110 may enable or configure the UE 120 with an uplink transmission extension capability. In this example, when the UE 120 is configured with the uplink transmission extension capability, the UE 120 may interpret the TAG identity field value to determine whether a received TA command MAC CE conveys an uplink transmission extension indication. Additionally, or alternatively, the UE 120 may interpret the TAG identity field value based on an LCID codepoint value. For example, when the UE 120 receives a TA command MAC CE with an LCID codepoint value configured to indicate inclusion of an uplink transmission extension indication, the UE 120 may interpret the TAG identity field value to determine whether to apply an uplink transmission extension.

As further shown in FIG. 6, and by reference number 660, the UE 120 set an uplink transmission extension timer. For example, based on interpreting the MAC CE as conveying an indication of extending the uplink transmission extension timer, the UE 120 may set a new uplink transmission extension timer or reset an existing uplink transmission extension timer. Additionally, or alternatively, the UE 120 may apply a TA command value. For example, when the UE 120 interprets a TA command MAC CE is conveying both an uplink transmission extension indication and a TA command value, the UE 120 may reset or extend the uplink transmission extension timer and may update a TA value that is used for timing synchronization.

In some aspects, the UE 120 may apply a MAC CE command (e.g., an uplink transmission timer extension command received in a TA command MAC CE) with a configured timing. For example, a MAC entity, of the UE 120, may wait until an expiration of a current T3xx timer to inform upper layers (e.g., an RRC entity), of the UE 120, of a restart of the T3xx timer and an extension of an uplink transmission period. In this example, the TA command MAC CE causes a second uplink transmission extension period to occur consecutively to a first uplink transmission extension period, resulting in two complete uplink transmission extension periods occurring for uplink transmission. In other words, when a TA command with an uplink transmission extension MAC CE is received, the UE 120 may apply an uplink transmission extension update to extend the first uplink transmission extension period (e.g., as a second uplink transmission extension period).

Additionally, or alternatively, the MAC entity, of the UE 120, may immediately request that the RRC entity, of the UE 120, restart the T3xx timer. In this example, the TA command MAC CE causes a second uplink transmission extension period to interrupt a first uplink transmission period, resulting in less than two complete uplink transmission extension periods occurring for uplink transmission. In other words, the UE 120 may experience a partial first T3xx timer period and a complete second T3xx timer period. Whether the TA command MAC CE is applied to extend an uplink transmission period immediately or after a completion of a prior uplink transmission period may be based on a signaled configuration, a specified static configuration, or an indicator in the TA command MAC CE.

As further shown in FIG. 6, and by reference number 670, the UE 120 may transmit one or more uplink transmissions. For example, during a period of time associated with the uplink transmission extension timer being active (e.g., before expiration of the uplink transmission extension timer), the UE 120 may transmit one or more uplink transmissions. In some aspects, the one or more uplink transmissions may include a second one or more uplink transmissions. For example, the UE 120 may transmit a first one or more uplink transmissions during a first period of time associated with a first uplink transmission extension timer (e.g., triggered by a first TA command MAC CE) and may transmit a second one or more uplink transmissions during a second period of time associated with a second uplink transmission extension timer (or a reset first uplink transmission extension timer) (e.g., triggered by a second TA command MAC CE). Although some aspects are described herein in terms of two uplink transmission extensions, any quantity of uplink transmission extensions may be used.

As indicated above, FIG. 6 is provided as an example. Other examples may differ from what is described with respect to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with uplink transmission timer extension.

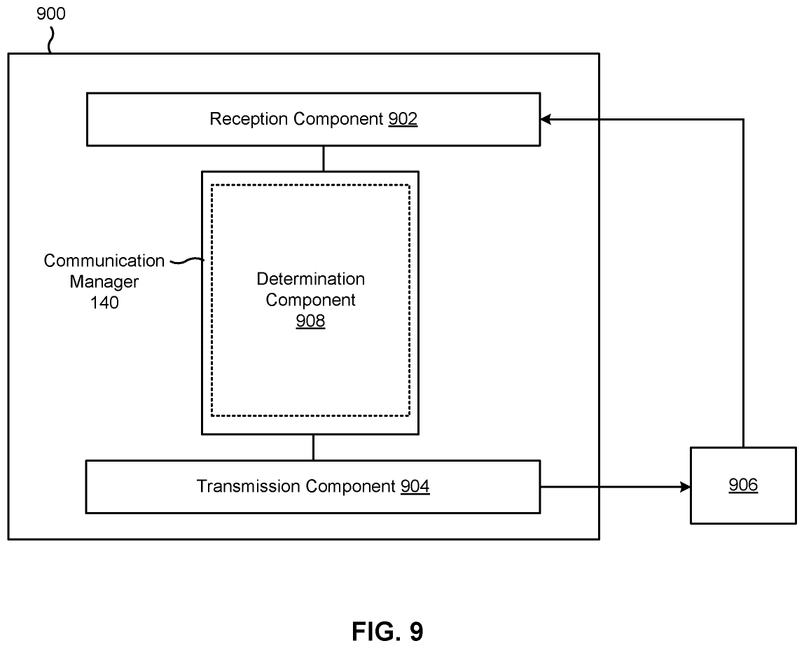

As shown in FIG. 7, in some aspects, process 700 may include receiving a closed loop timing advance command message including an indicator associated with the closed loop timing advance command message, the indicator including at least one of a timing advance value or an uplink transmission extension indication (block 710). For example, the UE (e.g., using communication manager 140 and/or reception component 902, depicted in FIG. 9) may receive a closed loop timing advance command message including an indicator associated with the closed loop timing advance command message, the indicator including at least one of a timing advance value or an uplink transmission extension indication, as described above.

As shown in FIG. 7, in some aspects, process 700 may include the indicator being included in an LCID value (block 720). For example, the UE (e.g., using communication manager 140 and/or reception component 902, depicted in FIG. 9) may receive a closed loop timing advance command message including an LCID value as an indicator of an interpretation of the closed loop timing advance command, as described above.

As shown in FIG. 7, in some aspects, process 700 may include the indicator being included in a TAG value (block 730). For example, the UE (e.g., using communication manager 140 and/or reception component 902, depicted in FIG. 9) may receive a closed loop timing advance command message including a TAG identity value as an indicator of an interpretation of the closed loop timing advance command, as described above.

As shown in FIG. 7, in some aspects, process 700 may include interpreting the closed loop timing advance command message as a timing advance command (block 740). For example, the UE (e.g., using communication manager 140 and/or determination component 908, depicted in FIG. 9) may interpret a content of the closed loop timing advance command message as including a timing advance command, as described above.

As shown in FIG. 7, in some aspects, process 700 may include interpreting the closed loop timing advance command message as an uplink transmission extension (block 750). For example, the UE (e.g., using communication manager 140 and/or determination component 908, depicted in FIG. 9) may interpret a content of the closed loop timing advance command message as including an uplink transmission extension, as described above.

As shown in FIG. 7, in some aspects, process 700 may include interpreting the closed loop timing advance command message as a timing advance command and an uplink transmission extension (block 760). For example, the UE (e.g., using communication manager 140 and/or determination component 908, depicted in FIG. 9) may interpret a content of the closed loop timing advance command message as including a timing advance command and an uplink transmission extension, as described above.

As further shown in FIG. 7, in some aspects, process 700 may include transmitting one or more communications on an uplink in accordance with an interpretation of the closed loop timing advance command message, the interpretation of the closed loop timing advance command message being based on the indicator (block 770). For example, the UE (e.g., using communication manager 140 and/or transmission component 904, depicted in FIG. 9) may transmit one or more communications on an uplink in accordance with an interpretation of the closed loop timing advance command message, the interpretation of the closed loop timing advance command message being based on the indicator, as described above.

Process 700 may include additional aspects, such as any single aspect or any combination of aspects described below and/or in connection with one or more other processes described elsewhere herein.

In a first aspect, the closed loop timing advance command message is a closed loop timing advance command MAC CE.

In a second aspect, alone or in combination with the first aspect, the indicator is a codepoint conveying a value that maps to at least one of the timing advance value or the uplink transmission extension indication.

In a third aspect, alone or in combination with one or more of the first and second aspects, the uplink transmission extension indication is associated with applying an uplink transmission extension update.

In a fourth aspect, alone or in combination with one or more of the first through third aspects, the uplink transmission extension update is applied to an uplink transmission extension timer after an expiration of the uplink transmission extension timer.

In a fifth aspect, alone or in combination with one or more of the first through fourth aspects, the uplink transmission extension update is applied to an uplink transmission extension timer before an expiration of the uplink transmission extension timer.

In a sixth aspect, alone or in combination with one or more of the first through fifth aspects, the indicator is associated with a TAG identity field.

In a seventh aspect, alone or in combination with one or more of the first through sixth aspects, a first value of the TAG identity field indicates that the closed loop timing advance command message conveys the timing advance value and the uplink transmission extension indication, and a second value of the TAG identity field indicates that the closed loop timing advance command message conveys the timing advance value and does not convey the uplink transmission extension indication.

In an eighth aspect, alone or in combination with one or more of the first through seventh aspects, the interpretation of the closed loop timing advance command message is based on a configuration of a UE capability.

In a ninth aspect, alone or in combination with one or more of the first through eighth aspects, the interpretation of the closed loop timing advance command message is based on a configured logical channel identity codepoint value associated with the closed loop timing advance command message.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with uplink transmission timer extension.

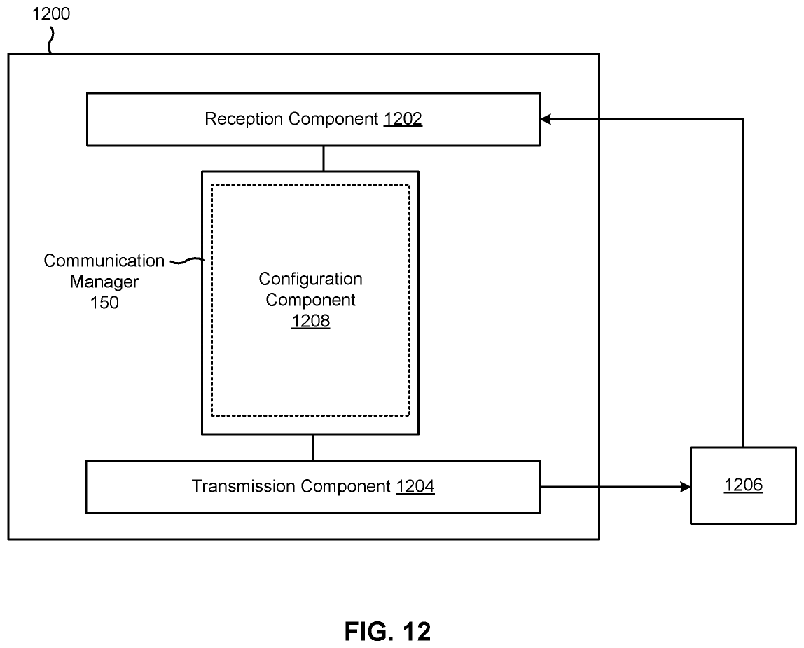

As shown in FIG. 8, in some aspects, process 800 may include transmitting a closed loop timing advance command message including an indicator associated with the closed loop timing advance command message, the indicator including at least one of a timing advance value or an uplink transmission extension indication (block 810). For example, the network node (e.g., using communication manager 150 and/or transmission component 1204, depicted in FIG. 12) may transmit a closed loop timing advance command message including an indicator associated with the closed loop timing advance command message, the indicator including at least one of a timing advance value or an uplink transmission extension indication, as described above.

As shown in FIG. 8, in some aspects, process 800 may include the indicator being included in an LCID value (block 820). For example, the network node (e.g., using communication manager 150 and/or transmission component 1204, depicted in FIG. 12) may transmit a closed loop timing advance command message including an LCID value as an indicator of an interpretation of the closed loop timing advance command, as described above.

As shown in FIG. 8, in some aspects, process 800 may include the indicator being included in a TAG value (block 830). For example, the network node (e.g., using communication manager 150 and/or transmission component 1204, depicted in FIG. 12) may transmit a closed loop timing advance command message including a TAG identity value as an indicator of an interpretation of the closed loop timing advance command, as described above.

As further shown in FIG. 8, in some aspects, process 800 may include receiving one or more communications on an uplink in accordance with an interpretation of the closed loop timing advance command message, the interpretation of the closed loop timing advance command message being based on the indicator (block 840). For example, the network node (e.g., using communication manager 150 and/or reception component 1202, depicted in FIG. 12) may receive one or more communications on an uplink in accordance with an interpretation of the closed loop timing advance command message, the interpretation of the closed loop timing advance command message being based on the indicator, as described above.

Process 800 may include additional aspects, such as any single aspect or any combination of aspects described below and/or in connection with one or more other processes described elsewhere herein.

In a first aspect, the closed loop timing advance command message is a closed loop timing advance command MAC CE.

In a second aspect, alone or in combination with the first aspect, the indicator is a codepoint conveying a value that maps to at least one of the timing advance value or the uplink transmission extension indication.

In a third aspect, alone or in combination with one or more of the first and second aspects, the uplink transmission extension indication is associated with applying an uplink transmission extension update.

In a fourth aspect, alone or in combination with one or more of the first through third aspects, the uplink transmission extension update is applied to an uplink transmission extension timer after an expiration of the uplink transmission extension timer.

In a fifth aspect, alone or in combination with one or more of the first through fourth aspects, the uplink transmission extension update is applied to an uplink transmission extension timer before an expiration of the uplink transmission extension timer.

In a sixth aspect, alone or in combination with one or more of the first through fifth aspects, the indicator is associated with a TAG identity field.

In a seventh aspect, alone or in combination with one or more of the first through sixth aspects, a first value of the TAG identity field indicates that the closed loop timing advance command message conveys the timing advance value and the uplink transmission extension indication, and a second value of the TAG identity field indicates that the closed loop timing advance command message conveys the timing advance value and does not convey the uplink transmission extension indication.

In an eighth aspect, alone or in combination with one or more of the first through seventh aspects, the interpretation of the closed loop timing advance command message is based on a configuration of a UE capability.

In a ninth aspect, alone or in combination with one or more of the first through eighth aspects, the interpretation of the closed loop timing advance command message is based on a configured logical channel identity codepoint value associated with the closed loop timing advance command message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a determination component 908, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The reception component 902 may receive a closed loop timing advance command message including an indicator associated with the closed loop timing advance command message, the indicator including at least one of a timing advance value or an uplink transmission extension indication. The transmission component 904 may transmit one or more communications on an uplink in accordance with an interpretation of the closed loop timing advance command message, the interpretation of the closed loop timing advance command message being based on the indicator. The determination component 908 may interpret a received closed loop timing advance command message to determine whether the closed loop timing advance command message conveys a timing advance command, an uplink transmission extension, or both a timing advance command and an uplink transmission extension. In other words, the determination component 908 may interpret a first value in the closed loop timing advance command message as indicating that the closed loop timing command conveys an uplink transmission extension and a timing advance value, a second value as indicating that the closed loop timing command conveys an uplink transmission extension and not a timing advance value, or a third value as indicating that the closed loop timing command conveys a timing advance value and not an uplink transmission extension, among other examples.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

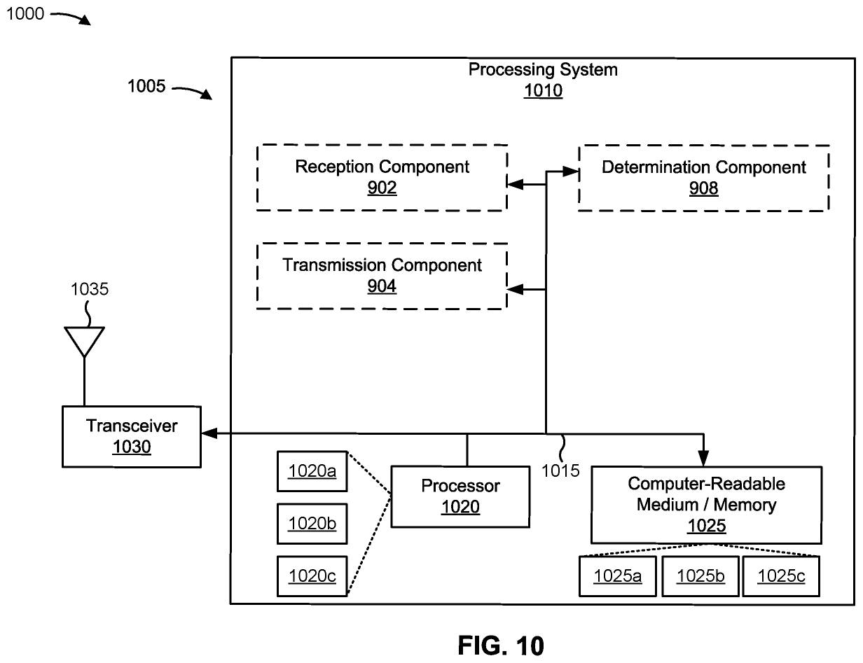

FIG. 10 is a diagram illustrating an example 1000 of a hardware implementation for an apparatus 1005 employing a processing system 1010, in accordance with the present disclosure. The apparatus 1005 may be a UE or may be at (e.g., included in) a UE.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors and/or hardware components, represented by one or more processors 1020 (e.g., the processors 1020a, 1020b, or 1020c), the illustrated components, and one or more computer-readable media/memories 1025 (e.g., the computer-readable media/memories 1025a, 1025b, or 1025c). The bus 1015 may also link various other circuits, such as timing sources, peripherals, voltage regulators, and/or power management circuits.

The processing system 1010 may be coupled to one or more transceivers 1030. A transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 902. In addition, the transceiver 1030 receives information from the processing system 1010, specifically the transmission component 904, and generates a signal to be applied to the one or more antennas 1035 based at least in part on the received information.

The processing system 1010 includes one or more processors 1020 coupled to a computer-readable medium/memory 1025. A processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the UE 120 and may include one or more memories, such as the memory 282, and/or may include one or more processors, such as at least one of the TX MIMO processor 266, the RX processor 258, and/or the controller/processor 280. In some aspects, the apparatus 1005 for wireless communication includes means for receiving a closed loop timing advance command message including an indicator associated with the closed loop timing advance command message, the indicator including at least one of a timing advance value or an uplink transmission extension indication; and means for transmitting one or more communications on an uplink in accordance with an interpretation of the closed loop timing advance command message, the interpretation of the closed loop timing advance command message being based on the indicator. The aforementioned means may be one or more of the aforementioned components of the apparatus 900 and/or the processing system 1010 of the apparatus 1005 configured to perform the functions recited by the aforementioned means. As described elsewhere herein, the processing system 1010 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 10 is provided as an example. Other examples may differ from what is described in connection with FIG. 10.

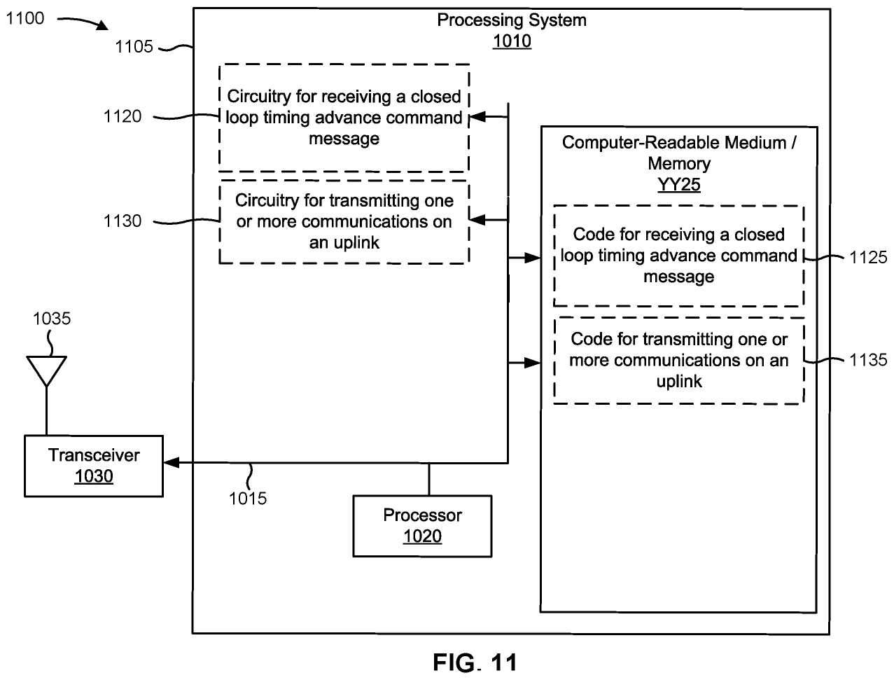

FIG. 11 is a diagram illustrating an example 1100 of an implementation of code and circuitry for an apparatus 1105, in accordance with the present disclosure. The circuitry may include processing circuitry and memory circuitry. The apparatus 1105 may be a UE, or a UE may include the apparatus 1105.

As shown in FIG. 11, the apparatus 1105 may include circuitry for receiving a closed loop timing advance command message including an indicator associated with the closed loop timing advance command message, the indicator including at least one of a timing advance value or an uplink transmission extension indication (circuitry 1120). For example, the circuitry 1120 may enable the apparatus 1105 to receive a closed loop timing advance command message including an indicator associated with the closed loop timing advance command message, the indicator including at least one of a timing advance value or an uplink transmission extension indication.

As shown in FIG. 11, the apparatus 1105 may include, stored in computer-readable medium 1025, code for receiving a closed loop timing advance command message including an indicator associated with the closed loop timing advance command message, the indicator including at least one of a timing advance value or an uplink transmission extension indication (code 1125). For example, the code 1125, when executed by processor 1020, may cause processor 1020 to cause transceiver 1030 to receive a closed loop timing advance command message including an indicator associated with the closed loop timing advance command message, the indicator including at least one of a timing advance value or an uplink transmission extension indication.

As shown in FIG. 11, the apparatus 1105 may include circuitry for transmitting one or more communications on an uplink in accordance with an interpretation of the closed loop timing advance command message, the interpretation of the closed loop timing advance command message being based on the indicator (circuitry 1130). For example, the circuitry 1130 may enable the apparatus 1105 to transmit one or more communications on an uplink in accordance with an interpretation of the closed loop timing advance command message, the interpretation of the closed loop timing advance command message being based on the indicator.

As shown in FIG. 11, the apparatus 1105 may include, stored in computer-readable medium 1025, code for transmitting one or more communications on an uplink in accordance with an interpretation of the closed loop timing advance command message, the interpretation of the closed loop timing advance command message being based on the indicator (code 1135). For example, the code 1135, when executed by processor 1020, may cause processor 1020 to cause transceiver 1030 to transmit one or more communications on an uplink in accordance with an interpretation of the closed loop timing advance command message, the interpretation of the closed loop timing advance command message being based on the indicator.

FIG. 11 is provided as an example. Other examples may differ from what is described in connection with FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a configuration component 1208, among other examples.

In some aspects, the apparatus 1200 may be configured to perform one or more operations described herein in connection with FIG. 6. Additionally, or alternatively, the apparatus 1200 may be configured to perform one or more processes described herein, such as process 800 of FIG. 8. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The transmission component 1204 may transmit a closed loop timing advance command message including an indicator associated with the closed loop timing advance command message, the indicator including at least one of a timing advance value or an uplink transmission extension indication. The reception component 1202 may receive one or more communications on an uplink in accordance with an interpretation of the closed loop timing advance command message, the interpretation of the closed loop timing advance command message being based on the indicator. The configuration component 1208 may configure a value in the closed loop timing advance command message to convey an indication of whether the closed loop timing advance command is for signaling a timing advance value, an uplink transmission extension, or both a timing advance value and an uplink transmission extension.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

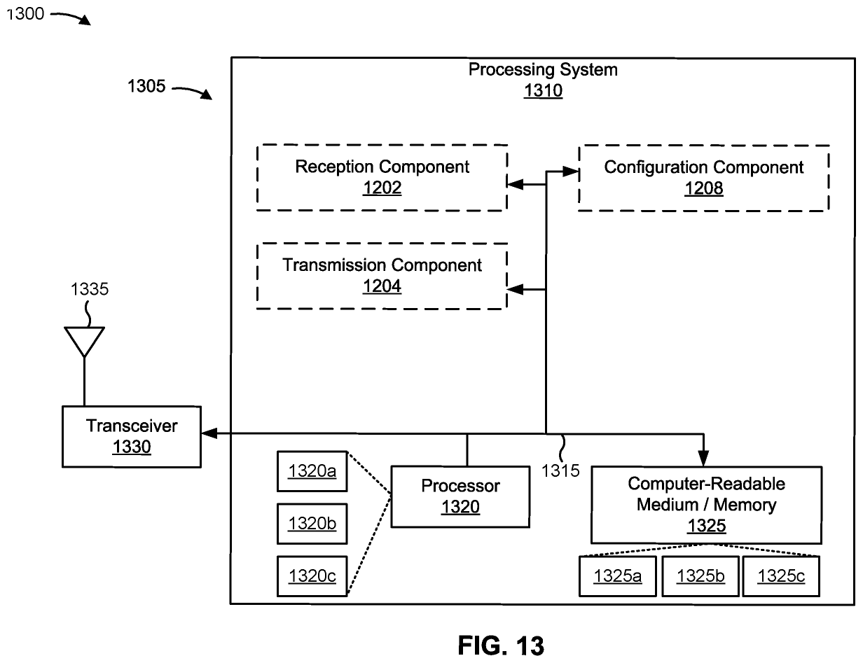

FIG. 13 is a diagram illustrating an example 1300 of a hardware implementation for an apparatus 1305 employing a processing system 1310, in accordance with the present disclosure. The apparatus 1305 may be a network node or may be at (e.g., included in) a network node.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the one or more processors 1320 (e.g., the processors 1320a, 1320b, or 1320c), the illustrated components, and one or more computer-readable media/memories 1325 (e.g., the computer-readable media/memories 1325a, 1325b, or 1325c). The bus 1315 may also link various other circuits, such as timing sources, peripherals, voltage regulators, and/or power management circuits.

The processing system 1310 may be coupled to one or more transceivers 1330. A transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes one or more processors 1320 coupled to a computer-readable medium/memory 1325. A processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the network node 110 and may include one or more memories, such as the memory 242, and/or may include one or more processors, such as at least one of the TX MIMO processor 216, the RX processor 238, and/or the controller/processor 240. In some aspects, the apparatus 1305 for wireless communication includes means for transmitting a closed loop timing advance command message including an indicator associated with the closed loop timing advance command message, the indicator including at least one of a timing advance value or an uplink transmission extension indication; and means for receiving one or more communications on an uplink in accordance with an interpretation of the closed loop timing advance command message, the interpretation of the closed loop timing advance command message being based on the indicator. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 13 is provided as an example. Other examples may differ from what is described in connection with FIG. 13.

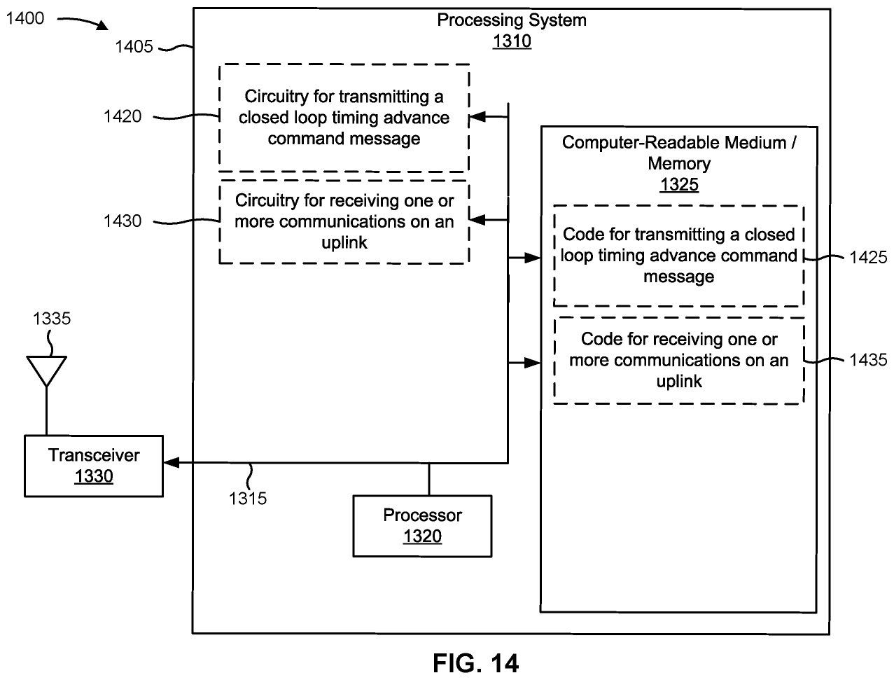

FIG. 14 is a diagram illustrating an example 1400 of an implementation of code and circuitry for an apparatus 1405, in accordance with the present disclosure. The circuitry may include processing circuitry and memory circuitry. The apparatus 1405 may be a network node, or a network node may include the apparatus 1405.

As shown in FIG. 14, the apparatus 1405 may include circuitry for transmitting a closed loop timing advance command message including an indicator associated with the closed loop timing advance command message, the indicator including at least one of a timing advance value or an uplink transmission extension indication (circuitry 1420). For example, the circuitry 1420 may enable the apparatus 1405 to transmit a closed loop timing advance command message including an indicator associated with the closed loop timing advance command message, the indicator including at least one of a timing advance value or an uplink transmission extension indication.

As shown in FIG. 14, the apparatus 1405 may include, stored in computer-readable medium 1325, code for transmitting a closed loop timing advance command message including an indicator associated with the closed loop timing advance command message, the indicator including at least one of a timing advance value or an uplink transmission extension indication (code 1425). For example, the code 1425, when executed by processor 1320, may cause processor 1320 to cause transceiver 1330 to transmit a closed loop timing advance command message including an indicator associated with the closed loop timing advance command message, the indicator including at least one of a timing advance value or an uplink transmission extension indication.

As shown in FIG. 14, the apparatus 1405 may include circuitry for receiving one or more communications on an uplink in accordance with an interpretation of the closed loop timing advance command message, the interpretation of the closed loop timing advance command message being based on the indicator (circuitry 1430). For example, the circuitry 1430 may enable the apparatus 1405 to receive one or more communications on an uplink in accordance with an interpretation of the closed loop timing advance command message, the interpretation of the closed loop timing advance command message being based on the indicator.

As shown in FIG. 14, the apparatus 1405 may include, stored in computer-readable medium 1325, code for receiving one or more communications on an uplink in accordance with an interpretation of the closed loop timing advance command message, the interpretation of the closed loop timing advance command message being based on the indicator (code 1435). For example, the code 1435, when executed by processor 1320, may cause processor 1320 to cause transceiver 1330 to receive one or more communications on an uplink in accordance with an interpretation of the closed loop timing advance command message, the interpretation of the closed loop timing advance command message being based on the indicator.

FIG. 14 is provided as an example. Other examples may differ from what is described in connection with FIG. 14.

The following provides an overview of some Aspects of the present disclosure:

Aspect 1: A method of wireless communication performed at a user equipment (UE), comprising: receiving a closed loop timing advance command message including an indicator associated with the closed loop timing advance command message, the indicator including at least one of a timing advance value or an uplink transmission extension indication; and transmitting one or more communications on an uplink in accordance with an interpretation of the closed loop timing advance command message, the interpretation of the closed loop timing advance command message being based on the indicator.

Aspect 2: The method of Aspect 1, wherein the closed loop timing advance command message is a closed loop timing advance command medium access control (MAC) control element (CE).

Aspect 3: The method of any of Aspects 1-2, wherein the indicator is a codepoint conveying a value that maps to at least one of the timing advance value or the uplink transmission extension indication.

Aspect 4: The method of any of Aspects 1-3, wherein the uplink transmission extension indication is associated with applying an uplink transmission extension update.

Aspect 5: The method of Aspect 4, wherein the uplink transmission extension update is applied to an uplink transmission extension timer after an expiration of the uplink transmission extension timer.

Aspect 6: The method of Aspect 4, wherein the uplink transmission extension update is applied to an uplink transmission extension timer before an expiration of the uplink transmission extension timer.

Aspect 7: The method of any of Aspects 1-6, wherein the indicator is associated with a timing advance group (TAG) identity field.

Aspect 8: The method of Aspect 7, wherein a first value of the TAG identity field indicates that the closed loop timing advance command message conveys the timing advance value and the uplink transmission extension indication, and wherein a second value of the TAG identity field indicates that the closed loop timing advance command message conveys the timing advance value and does not convey the uplink transmission extension indication.

Aspect 9: The method of any of Aspects 1-8, wherein the interpretation of the closed loop timing advance command message is based on a configuration of a UE capability.

Aspect 10: The method of any of Aspects 1-9, wherein the interpretation of the closed loop timing advance command message is based on a configured logical channel identity codepoint value associated with the closed loop timing advance command message.

Aspect 11: A method of wireless communication performed by a network node, comprising: transmitting a closed loop timing advance command message including an indicator associated with the closed loop timing advance command message, the indicator including at least one of a timing advance value or an uplink transmission extension indication; and receiving one or more communications on an uplink in accordance with an interpretation of the closed loop timing advance command message, the interpretation of the closed loop timing advance command message being based on the indicator.

Aspect 12: The method of Aspect 11, wherein the closed loop timing advance command message is a closed loop timing advance command medium access control (MAC) control element (CE).

Aspect 13: The method of any of Aspects 11-12, wherein the indicator is a codepoint conveying a value that maps to at least one of the timing advance value or the uplink transmission extension indication.

Aspect 14: The method of any of Aspects 11-13, wherein the uplink transmission extension indication is associated with applying an uplink transmission extension update.

Aspect 15: The method of Aspect 14, wherein the uplink transmission extension update is applied to an uplink transmission extension timer after an expiration of the uplink transmission extension timer.

Aspect 16: The method of Aspect 14, wherein the uplink transmission extension update is applied to an uplink transmission extension timer before an expiration of the uplink transmission extension timer.

Aspect 17: The method of any of Aspects 11-16, wherein the indicator is associated with a timing advance group (TAG) identity field.

Aspect 18: The method of Aspect 17, wherein a first value of the TAG identity field indicates that the closed loop timing advance command message conveys the timing advance value and the uplink transmission extension indication, and wherein a second value of the TAG identity field indicates that the closed loop timing advance command message conveys the timing advance value and does not convey the uplink transmission extension indication.

Aspect 19: The method of any of Aspects 11-18, wherein the interpretation of the closed loop timing advance command message is based on a configuration of a UE capability.

Aspect 20: The method of any of Aspects 11-19, wherein the interpretation of the closed loop timing advance command message is based on a configured logical channel identity codepoint value associated with the closed loop timing advance command message.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 28: An apparatus for wireless communication at a user equipment (UE), comprising: one or more memories; and one or more processors coupled to the one or more memories, the one or more processors configured to cause the UE to: receive a closed loop timing advance command message including an indicator associated with the closed loop timing advance command message, the indicator including at least one of a timing advance value or an uplink transmission extension indication; and transmit one or more communications on an uplink in accordance with an interpretation of the closed loop timing advance command message, the interpretation of the closed loop timing advance command message being based on the indicator.

Aspect 29: The apparatus of Aspect 28, wherein the one or more processors are configured, individually or collectively, to cause the UE to: receive the closed loop timing advance command message including the indicator associated with the closed loop timing advance command message, the indicator including at least one of the timing advance value or the uplink transmission extension indication; and transmit one or more communications on an uplink in accordance with an interpretation of the closed loop timing advance command message, the interpretation of the closed loop timing advance command message being based on the indicator.

Aspect 30: An apparatus for wireless communication at a network node, comprising: one or more memories; and one or more processors coupled to the one or more memories, the one or more processors configured to cause the network node to: transmit a closed loop timing advance command message including an indicator associated with the closed loop timing advance command message, the indicator including at least one of a timing advance value or an uplink transmission extension indication; and receive one or more communications on an uplink in accordance with an interpretation of the closed loop timing advance command message, the interpretation of the closed loop timing advance command message being based on the indicator.

Aspect 31: The apparatus of Aspect 30, wherein the one or more processors are configured, individually or collectively, to cause the network node to: transmit the closed loop timing advance command message including the indicator associated with the closed loop timing advance command message, the indicator including at least one of the timing advance value or the uplink transmission extension indication; and receive one or more communications on the uplink in accordance with an interpretation of the closed loop timing advance command message, the interpretation of the closed loop timing advance command message being based on the indicator.

A user equipment (UE), comprising: a processing system that includes processor circuitry and memory circuitry that stores code and is coupled with the processor circuitry, the processing system configured to cause the UE to: receive a closed loop timing advance command message including an indicator associated with the closed loop timing advance command message, the indicator including at least one of a timing advance value or an uplink transmission extension indication; and transmit one or more communications on an uplink in accordance with an interpretation of the closed loop timing advance command message, the interpretation of the closed loop timing advance command message being based on the indicator.

A network node, comprising: a processing system that includes processor circuitry and memory circuitry that stores code and is coupled with the processor circuitry, the processing system configured to cause the network node to: transmit a closed loop timing advance command message including an indicator associated with the closed loop timing advance command message, the indicator including at least one of a timing advance value or an uplink transmission extension indication; and receive one or more communications on an uplink in accordance with an interpretation of the closed loop timing advance command message, the interpretation of the closed loop timing advance command message being based on the indicator.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories and configured to cause the UE to:
receive a closed loop timing advance command message that includes an indicator associated with the closed loop timing advance command message, wherein the indicator includes at least one of a timing advance value or an uplink transmission extension indication; and
transmit one or more communications on an uplink in accordance with an interpretation of the closed loop timing advance command message, the interpretation of the closed loop timing advance command message being based on the indicator.

2. The apparatus of claim 1, wherein the closed loop timing advance command message is a closed loop timing advance command medium access control (MAC) control element (CE).

3. The apparatus of claim 1, wherein the indicator is a codepoint that conveys a value that maps to at least one of the timing advance value or the uplink transmission extension indication.

4. The apparatus of claim 1, wherein the uplink transmission extension indication is associated with an application of an uplink transmission extension update.

5. The apparatus of claim 4, wherein the uplink transmission extension update is applied to an uplink transmission extension timer after an expiration of the uplink transmission extension timer.

6. The apparatus of claim 4, wherein the uplink transmission extension update is applied to an uplink transmission extension timer before an expiration of the uplink transmission extension timer.

7. The apparatus of claim 1, wherein the indicator is associated with a timing advance group (TAG) identity field.

8. The apparatus of claim 7, wherein a first value of the TAG identity field indicates that the closed loop timing advance command message conveys the timing advance value and the uplink transmission extension indication, and
wherein a second value of the TAG identity field indicates that the closed loop timing advance command message conveys the timing advance value and does not convey the uplink transmission extension indication.

9. The apparatus of claim 1, wherein the interpretation of the closed loop timing advance command message is based on a configuration of a UE capability.

10. The apparatus of claim 1, wherein the interpretation of the closed loop timing advance command message is based on a configured logical channel identity codepoint value associated with the closed loop timing advance command message.

11. An apparatus for wireless communication at a network node, comprising:
one or more memories; and
one or more processors, coupled to the one or more memories and configured to cause the network node to:
transmit a closed loop timing advance command message that includes an indicator associated with the closed loop timing advance command message, wherein the indicator includes at least one of a timing advance value or an uplink transmission extension indication; and
receive one or more communications on an uplink in accordance with an interpretation of the closed loop timing advance command message, the interpretation of the closed loop timing advance command message being based on the indicator.

12. The apparatus of claim 11, wherein the closed loop timing advance command message is a closed loop timing advance command medium access control (MAC) control element (CE).

13. The apparatus of claim 11, wherein the indicator is a codepoint that conveys a value that maps to at least one of the timing advance value or the uplink transmission extension indication.

14. The apparatus of claim 11, wherein the uplink transmission extension indication is associated with an application of an uplink transmission extension update.

15. The apparatus of claim 14, wherein the uplink transmission extension update is applied to an uplink transmission extension timer after an expiration of the uplink transmission extension timer.

16. The apparatus of claim 14, wherein the uplink transmission extension update is applied to an uplink transmission extension timer before an expiration of the uplink transmission extension timer.

17. The apparatus of claim 11, wherein the indicator is associated with a timing advance group (TAG) identity field.

18. The apparatus of claim 17, wherein a first value of the TAG identity field indicates that the closed loop timing advance command message conveys the timing advance value and the uplink transmission extension indication, and
wherein a second value of the TAG identity field indicates that the closed loop timing advance command message conveys the timing advance value and does not convey the uplink transmission extension indication.

19. The apparatus of claim 11, wherein the interpretation of the closed loop timing advance command message is based on a configuration of a UE capability.

20. A method of wireless communication performed at a user equipment (UE), comprising:
receiving a closed loop timing advance command message including an indicator associated with the closed loop timing advance command message, the indicator including at least one of a timing advance value or an uplink transmission extension indication; and
transmitting one or more communications on an uplink in accordance with an interpretation of the closed loop timing advance command message, the interpretation of the closed loop timing advance command message being based on the indicator.
